(19) United States
(12) Patent Application Publication
(10) Pub. No.: US 2026/0076431 A1
(43) Pub. Date: Mar. 19, 2026

(54) METHOD FOR PRODUCING A GARMENT OR BAG, ASSOCIATED COMPUTER PROGRAM AND ASSOCIATED SYSTEM

(71) Applicant: Céline SHEN, CHAPON (FR)

(72) Inventor: Céline SHEN, CHAPON (FR)

(21) Appl. No.: 18/872,987

(22) PCT Filed: Jun. 15, 2023
(86) PCT No.: PCT/IB2023/056206

§ 371 Date: Dec. 9, 2024

(30) Foreign Application Priority Data
Jun. 15, 2022 (FR) FR220582I

(51) Int. Cl. A41H 3/00

(52) U.S. Cl. CPC A41H 3/007

(57) ABSTRACT

A method for producing a garment or bag that is better adapted to the body shape of the consumer whilst reducing the use of raw material as well as the time and costs involved in the creative process is disclosed. The method
includes recording a digital reference template,
generating a digital production template for the garment or bag,
recording the digital production template in a database,
and repeating the recording of a digital reference templated and the generation of a digital production. The method further includes
Establishing at least one selection criterion,
Selecting, from the database, at least two digital production templates corresponding to the at least one selection criterion,
determining the final digital production template from among the selected digital production templates, and
producing the garment or bag in accordance with the final digital production template.

### TECHNICAL FIELD OF THE INVENTION

The present invention relates to the technical field of fashion items such as clothing and leather goods, and more specifically to methods for producing such fashion items.

### PRIOR ART

Fashion items such as garments and bags, etc. are known. Generally speaking, the creative process for producing a garment or bag is as follows. A creator or stylist starts by designing a template for the garment or bag, which is the design stage. A prototype of the garment or bag is then produced by cutting, then, by assembling, for example by sewing various pieces of fabric, leather or other material according to the template, which is the prototyping stage. If necessary, modifications are made to the template in order to produce a final template, which is the development stage. A plurality of prototyping stages may take place during the development stage in order to validate the various modifications. Finally, once the design has been accepted, the garment or bag is produced on an industrial scale by cutting and assembling different pieces of fabric, leather or other material according to the final template, this is the production stage. When the design is not accepted, the template is discarded or destroyed.

However, the creative process which comprises numerous steps is generally long and costly. In particular, the prototyping stage requires very expensive skilled labor. Therefore, due to the time required for the creative process, it is only possible to propose a limited number of different designs each season. Moreover, in order to make the costs associated with the creative process more profitable, the garment or bag is generally proposed in bulk. The garment or bag is therefore designed to be worn by the largest number of people without being adapted to the body shape of the individual.

The object of the invention is therefore to provide a method for producing a garment or bag that is better adapted to the body shape of the consumer whilst reducing the use of raw material as well as the time and costs, in particular labor, involved in the creative process, and in particular, the time and costs associated with the design, prototyping and development stages.

### DISCLOSURE OF THE INVENTION

The solution proposed by the invention is a method for producing a garment or bag comprising the following steps:
a) Recording a digital reference template for producing a garment or bag having a set of fixed digital points,
b) Generating a digital production template for the garment or bag comprising the set of fixed digital points of the digital reference template and at least one digital line connecting at least two fixed digital points,
c) Recording the digital production template in a database,
d) Repeating steps b) and c) a determined number of times,
e) Establishing at least one selection criterion,
f) Selecting, from the database, at least two digital production templates corresponding to the at least one selection criterion,
g) Determining the final digital production template from among the selected digital production templates,
h) Producing the garment or bag in accordance with the final digital production template.

It is thus possible to quickly create a large number of digital templates according to criteria adapted to the customer. It is therefore possible to produce a garment or bag without having to produce a plurality of physical templates. This significantly reduces the use of raw material. This same goes for the time and costs involved in the creative process. The use of knitted or non-woven fabrics during the step for producing the garment or bag helps avoid any waste of raw materials.

According to one advantageous feature of the invention providing the user with a large number of digital template options, in step d) the determined number of times is greater than or equal to 1000.

According to another advantageous feature of the invention enabling the user to enter their own criteria, step e) comprises the step of:
e1) Retrieving at least one criterion entered via a user interface.

According to yet another advantageous feature of the invention for producing a fashion item adapted to the body measurements of a consumer, step e) comprises the step of:
e2) Acquiring body measurements.

According to yet another advantageous feature of the invention which makes it possible to eliminate the prototyping stage for the garment or bag, step g) comprises the steps of:
g1) Displaying, for each selected digital production template, a three-dimensional rendering of the garment or bag that can be produced in accordance with said template,
g2) Retrieving a selection of the final digital template entered via a user interface.

According to yet another advantageous feature of the invention which ensures that the garment or bag is adapted to the body shape of a user, step g) comprises the steps of:
g1) Displaying, for each selected digital production template:
g11) A three-dimensional rendering of the garment or bag that can be produced in accordance with said template,
g12) A three-dimensional rendering of the body measurements inside the three-dimensional rendering of the garment or bag,
g2) Retrieving a selection of the final digital template entered via a user interface.

According to yet another advantageous feature of the invention for creating a usable history of the selections made by the user(s), the method comprises the step of:
j) Recording a piece of correlation data between the at least one selection criterion established and the final digital production template.

According to yet another advantageous feature of the invention for gradually improving the selection of digital templates using a machine learning method, step f) comprises the following steps:
f1) Comparing the at least one selection criterion with each piece of correlation data previously recorded,
f2) Selecting, from the database, at least two digital production templates for which the at least one selection criterion corresponds to the piece of correlation data previously recorded.

Another aspect of the invention relates to a garment or bag characterized in that it is produced according to the method which is the object of the invention.

The garment or bag is thus better adapted to the criteria of the client and obtained in less time.

Another aspect of the invention relates to a computer program characterized in that it is designed to be run by a microprocessor so as to carry out the steps of the method for producing a garment or bag which is the object of the invention.

Another aspect of the invention relates to a system for carrying out the method for producing a garment or bag which is the object of the invention. This system is characterized in that is comprises:
A microprocessor able to run a computer program so as to carry out the steps of said production method,
A computer mass storage device on which said computer program is stored, said mass storage device being designed to record the digital reference template (1), the digital production templates (3), and the final digital production template,
A user interface designed to display the selected digital production templates and enable the selection of one of said selected digital production templates so as to determine the final digital production template from among the selected digital production templates,
A digital production unit designed to produce the garment or bag in accordance with the final digital production template.

According to yet another advantageous feature of the invention enabling a realistic rendering of the digital templates, the user interface comprises a virtual reality headset.

### DESCRIPTION OF THE FIGURES

Other features and advantages of the invention will become apparent from reading the description below of specific embodiments of the invention, provided by way of example and in a non-limiting manner, with reference to the appended drawings in which:

FIG. 1 is a schematic view of an exemplary digital reference template;

FIG. 2 is a schematic view of an exemplary digital production template generated based on the digital reference template shown in FIG. 1;

FIG. 3 is a schematic view of an exemplary additional digital reference template;

FIG. 4 is a schematic view of the superimposition of the digital reference template shown in FIG. 1 and the additional digital reference template shown in FIG. 3;

FIG. 5 is a schematic view of an exemplary digital production template generated in the space comprised between the first reference template shown in FIG. 1 and the second reference template shown in FIG. 3.

### DETAILED DESCRIPTION

The invention relates to a method for producing a garment or bag. The garment or bag may be a dress, a pair of trousers, a coat, a jacket, a glove, a handbag or any garment or bag appropriate for a person skilled in the art. The garment or bag is produced by assembling together at least two pieces. One piece may be made of fabric, leather, synthetic material, or any other material appropriate for a person skilled in the art. The different pieces may be made of the same material or different materials. They may be assembled by sewing, knitting, buttoning, hook and loop fastener, or any other assembly means appropriate for a person skilled in the art.

The production method which is the object of the invention comprises the step of:
a) Recording a digital reference template (1) for producing a garment or bag having a set of digital points.

“Digital” is understood to mean the representation of an object in the form of computer data. For example, a digital template is the representation of a template in the form of computer data.

A digital template is in the form of a set of digital points. The digital points are arranged in a two-or three-dimensional digital space. These digital points form one or more digital lines, straight or curved, joined together to generate the digital shape of the garment or bag. The template may be made up of a set of sub-templates. Each sub-template is in the form of a set of digital points, the latter forming one or more digital lines, straight or curved, joined together to generate the digital shape of parts of the garment or bag, the assembly of the digital shapes of said parts producing the digital shape of said garment or bag.

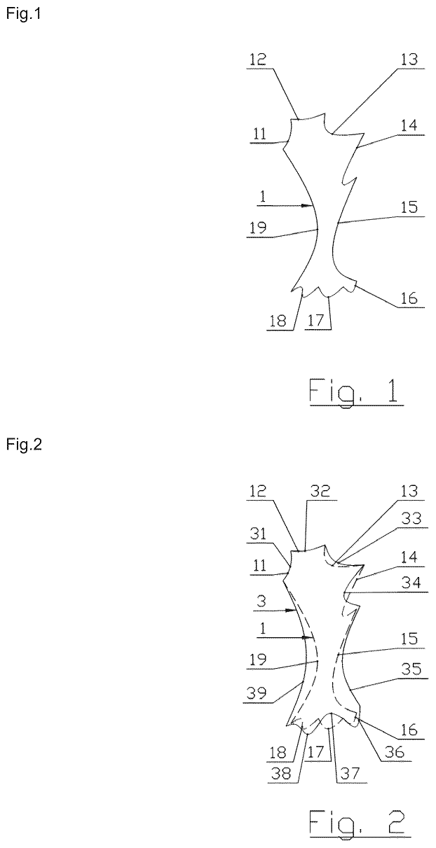

The digital reference template (1) is in the form of at least one part of a digital template as described above. The digital reference template (1) has a set of fixed digital points. It serves as the basis for creating a complete digital template. In some embodiments, the digital reference template (1) may be in the form of a complete digital template. As in the exemplary embodiment shown in Figure [FIG. 1], the digital reference template (1) may comprise 9 digital lines (11, 12, 13, 14, 15, 16, 17, 18, 19).

In practice, the execution of a computer program by a microprocessor enables it to be stored on a computer mass storage medium such as a hard disk drive (HDD), solid state drive (SSD) or any other computer mass storage medium appropriate for a person skilled in the art.

Prior to recording, the digital reference template (1) may be imported from a pre-existing digital template. In practice, the execution of a computer program by a microprocessor enables the digital template to be imported.

In one alternative embodiment, prior to recording, the digital reference template (1) may be generated by means of a user interface and a computer program run by a microprocessor. The computer program may, for example, be a computer-aided design (CAD) software, a computer-aided drafting (CAD) software or any other computer program appropriate for a person skilled in the art. The user interface may consist of a graphical interface displayed by a screen and an active interface comprising individually or in combination a keyboard, a mouse, a touchscreen, a stylus or any other active interface appropriate for a person skilled in the art. In practice, the user draws the digital lines of the digital reference template (1) by means of the user interface. The digital reference template (1) is then stored on a computer mass storage medium of the type described above.

In another alternative embodiment, prior to recording, the digital reference template (1) may either be imported from a pre-existing digital template or generated by means of a user interface and a computer program run by a microprocessor.

In yet another alternative embodiment, prior to step a), the production method which is the object of the invention may comprise the steps of:
a01) Acquiring measurements of an immobile body,
a02) Generating a digital reference template (1) based on the acquired measurements.

In step a01), the measurements of the immobile body may be taken by means of a three-dimensional (3D) body scanner such as those available on the market or by any other means appropriate for a person skilled in the art. In particular, sensors may be positioned on an immobile body and the position of the sensors in space may be recorded.

In step a02), generating the digital reference template (1) may comprise the following sub-steps:
a021) Extrapolating a volume from the acquired measurements,
a022) Creating an envelope surrounding the volume,
a023) Potentially modifying one or more determined parts of the envelope, for example to add functional clearances to the parts opposite the body joints,
a024) Determining one or more assembly areas of the envelope so as to create the digital reference template (1).

In practice, the execution of a computer program by a microprocessor enables step a02) and its sub-steps to be carried out. The software may, in particular, be designed to determine, in step a023), the parts of the envelope to be modified, for example the parts of the envelope arranged opposite the body joints. In alternative embodiments, the user may initiate modifications in step a023) via a user interface of the type described above. The user interface may also be in the form of a virtual or augmented reality interface, and for example comprise a virtual or augmented reality headset. The modifications in step a023) may be initiated by one or more movements of the hand of the user, of a remote control, of a stylus or of any other element or means for controlling actions through the virtual or augmented reality interface.

In step a), the production method which is the object of the invention may also comprise the step of:
a1) Determining from among the digital points of the digital reference template (1) a set of fixed position fixed digital points.

In step a), the production method which is the object of the invention may also comprise the step of:
a2) Determining from among the digital points of the digital reference template (1) variable position variable digital points.

In practice, the execution of a computer program by a microprocessor enables step a1) and/or a2) to be carried out. The software may, in particular, be designed to determine from among the digital points of the digital reference template (1) the variable position variable digital points, the remainder of the points being fixed position fixed digital points. Conversely, the software may be designed to determine from among the digital points of the digital reference template (1) the fixed position fixed digital point(s), the remainder of the points being variable position variable digital points. In alternative embodiments, in order to determine the fixed or variable digital points, the user may select the fixed digital points and/or the variable digital points through a user interface of the time described above. The user interface may also be in the form of a virtual or augmented reality interface, and for example comprise a virtual or augmented reality headset. The fixed digital points and/or the variable digital points may be selected by one or more movements of the hand of the user, of a remote control, of a stylus or of any other element or means for controlling actions through the virtual or augmented reality interface.

In the exemplary embodiment shown in Figure [FIG. 1], the digital points forming the digital segments (11 and 12) are fixed digital points, all of the other digital points being variable digital points.

In one alternative embodiment, the production method which is the object of the invention may also comprise the step of:
a′) Generating an additional digital reference template (2) for producing the garment or bag having a set of digital points.

The digital reference template (1) may then correspond to a minimum generation envelope and the additional digital reference template (2) may correspond to a maximum generation envelope. Alternatively, the digital reference template (1) may correspond to a maximum generation envelope and the additional digital reference template (2) may correspond to a minimum generation envelope.

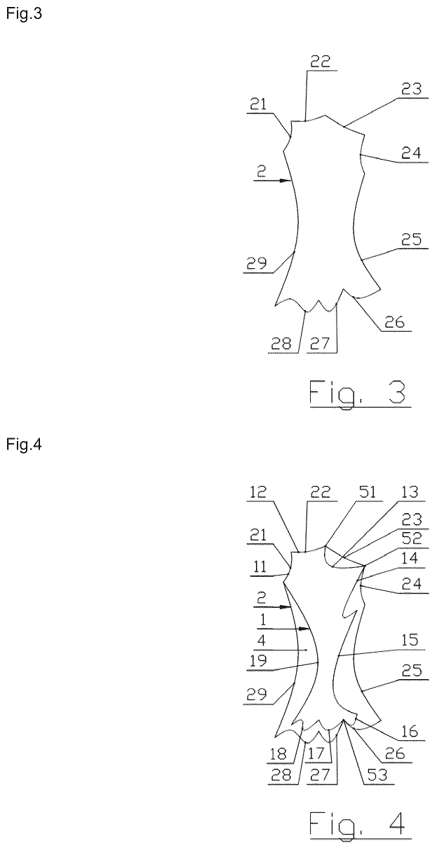

The additional digital reference template (2) is in the form of a digital reference template as described above. It may comprise more, fewer or the same number of digital points as the digital reference template (1). The digital points of the additional digital reference template (2) may form more, fewer or the same number of digital lines as the digital reference template (1). As in the exemplary embodiment shown in Figure [FIG. 3], the additional digital reference template (2) may comprise 9 digital lines (21, 22, 23, 24, 25, 26, 27, 28, 29).

The additional digital reference template (2) may not comprise any part in common with the digital reference template (1). In alternative embodiments, the additional digital reference template (2) may comprise at least one part in common with the digital reference template (1). The at least one part in common may take the form of a digital point or a digital line. As in the exemplary embodiment shown in Figure [FIG. 3], the additional digital reference template (2) may comprise:
A first digital line (21) in common with a first digital line (11) of the digital reference template (1),
A second digital line (22) in common with a second digital line (12) of the digital reference template (1),
Three digital points (51, 52, 53) in common with the digital reference template (1).

Similarly to the digital reference template (1), the execution of a computer program by a microprocessor enables it to be stored on a computer mass storage medium of the type described above.

In addition, and similarly to the digital reference template (1), the additional digital reference template (2) may, prior to recording, be imported from a pre-existing digital template or generated by means of a user interface and a computer program run by a microprocessor.

Also, and similarly to the digital reference template (1), prior to step a′), the production method which is the object of the invention may comprise the steps of:
a′01) Acquiring measurements of the moving body,
a02) Generating an additional digital reference template (2) based on the acquired measurements.

It is therefore possible to produce a garment or bag that is better adapted to the body shape of the consumer without having to produce a plurality of physical templates.

In step a′01), the measurements of the moving body may be taken by means of a three-dimensional (3D) body scanner such as those available on the market or by any other means appropriate for a person skilled in the art. In particular, sensors may be positioned on a moving body and the successive positions of the sensors in space may be recorded. In one alternative embodiment, the body scanner may be in the form of a video volumetric capture device, for example of the Azure Kinect type. In one alternative embodiment, the body scanner may be in the form of a radar volumetric capture device. The volume delimited by the moving body is thus necessarily larger than the volume delimited by the immobile body. In addition, by acquiring measurements on a moving body, it is possible to generate an additional digital reference template (2) that is particularly suited to the dynamics of the body.

In step a′02), generating the additional digital reference template (2) may comprise the following sub-steps:
a′021) Extrapolating a volume from the acquired measurements,
a′022) Creating an envelope surrounding the volume,
a′023) Potentially modifying one or more determined parts of the envelope, for example to add functional clearances to the parts opposite the body joints,
a′024) Determining one or more assembly areas of the envelope so as to create the additional digital reference template (2).

In practice, the execution of a computer program by a microprocessor enables step a′02) and its sub-steps to be carried out. The software may, in particular, be designed to determine, in step a′023), the parts of the envelope to be modified, for example the parts of the envelope arranged opposite the body joints. In alternative embodiments, the user may initiate modifications in step a′023) via a user interface of the type described above. The user interface may also be in the form of a virtual or augmented reality interface, and for example comprise a virtual or augmented reality headset. In particular, the interface may include a means for displaying a three-dimensional rendering of the template, inside of which a three-dimensional rendering of the moving body extrapolated from the measurements acquired in step a′01) may be displayed. The modifications in step a′023) may be initiated by one or more movements of the hand of the user, of a remote control, of a stylus or of any other element or means for controlling actions through the virtual or augmented reality interface.

When the method comprises generating an additional digital reference template (2), the production method which is the object of the invention may then comprise the step of:
a′1) Determining from among the digital points of the additional digital reference template (2) a set of fixed position fixed digital points.

In step a′), the production method which is the object of the invention may also comprise the step of:
a′2) Determining from among the digital points of the additional digital reference template (2) variable position variable digital points.

As for the digital reference template (1), the execution of a computer program by a microprocessor enables step a′1) and/or a′2) to be carried out. The fixed digital points and/or the variable digital points are selected in a similar way to that described above for the digital reference template (1) using the same type of interface.

The production method which is the object of the invention also comprises the step of:
b) Generating a digital production template (3) for the garment or bag comprising the set of fixed digital points of the digital reference template (1) and at least one digital line connecting at least two fixed digital points.

When the digital reference template (1) has variable digital points, the at least one digital line connecting at least two fixed digital points may be obtained by modifying the position of at least some of said variable digital points.

When the method comprises generating an additional digital reference template (2), the production method which is the object of the invention may also comprise the step of:
b′) Generating an additional digital production template for the garment or bag comprising the set of fixed digital points of the additional digital reference template (2) and at least one digital line connecting at least two fixed digital points.

When the additional digital reference template (2) has variable digital points, the at least one digital line connecting at least two fixed digital points may be obtained by modifying the position of at least some of the variable digital points.

When the method comprises generating an additional digital reference template (2), the modified position of at least some of the variable digital points is such that the digital production template (3) extends into a space (4) delimited by the minimum generation envelope and the maximum generation envelope. With reference to Figure [FIG. 4], the digital reference template (1) and the additional digital reference template (2) delimit a space (4) inside of which digital production templates can be generated. The space (4) includes its boundaries, i.e. the digital reference template (1) and the additional digital reference template (2).

Similarly, when an additional digital production template is generated, the modified position of at least some of the variable digital points is such that said additional digital production template extends into a space (4) delimited by the minimum generation envelope and the maximum generation envelope.

In alternative embodiments, the modified position of at least some of the variable digital points is such that the digital production template (3) extends at least partly outside of the space (4) delimited by the minimum generation envelope and the maximum generation envelope. Similarly, the modified position of at least some of the variable digital points may be such that the additional digital production template extends at least partly outside of the space (4) delimited by the minimum generation envelope and the maximum generation envelope.

The digital production template (3) is in the form of a digital template as described above. It may comprise more, fewer or the same number of digital points, and by extension digital lines, as the digital reference template (1). In particular when the digital reference template (1) only comprises a set of fixed digital points, the digital production template (3) has more digital points than the digital reference template (1). When the digital reference template (1) comprises, in addition to the set of fixed digital points, variable digital points, the digital production template (3) may comprise more, fewer, or the same number of digital points as the digital reference template (1). Indeed, when several digital points are moved to the same location, they may be merged. Similarly, when two initially close digital points are moved apart, additional digital points may be created. In addition, digital lines connecting at least two fixed digital points may be generated, in addition to the modification of the position of at least some of the variable digital points.

In the exemplary embodiment shown in Figure [FIG. 2], the digital production template (3) comprises 9 digital lines (31, 32, 33, 34, 35, 36, 37, 38, 39). The digital lines (31 and 32) of the digital production template (3) are identical to the digital lines (11 and 12) of the digital reference template (1) given that the points forming the digital lines (11 and 12) are fixed points.

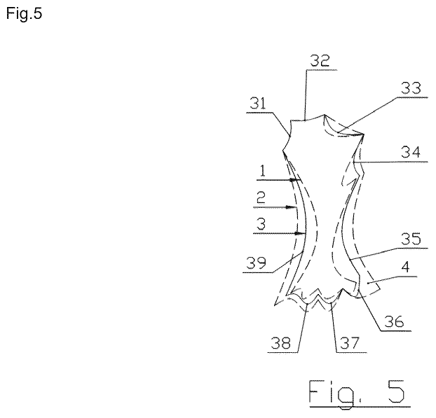

When the space exists (4), all of the digital lines of the digital production template (3) may be included in the space (4). In other words, all of the digital lines of the digital production template (3) are included on, or between, the digital reference template (1) and the additional digital reference template (2). As in the exemplary embodiment shown in Figure [FIG. 5], the digital production template (3) may comprise 9 digital lines (31, 32, 33, 34, 35, 36, 37, 38, 39).

The additional digital production template is in the form of a digital template as described above. Similarly to the digital production template (3), the additional digital production template may comprise more, fewer, or the same number of digital points, and by extension digital lines, as the additional digital reference template (2).

When the space exists (4), all of the digital lines of the additional digital production template may be included in the space (4). In other words, all of the digital lines of the digital production template (3) are included on, or between, the digital reference template (1) and the additional digital reference template (2).

When the digital reference template (1) and the additional digital reference template (2) have one or more parts in common, these parts in common may correspond to fixed points of the digital reference template (1) and the additional digital reference template (2). In such a case, the digital production template (3) also has said part(s) in common with the digital reference template (1) and the additional digital reference template (2). The fixed points generally correspond to a part of the garment or bag with which a function is associated. For this function to exist, it is important to retain the shape and dimensions of this part. The part of the garment or bag may, for example, be an armhole, a neckline, or other. The part of the garment or bag may also correspond to a part able to interconnect with other garments or bags. This is in particular the case when a garment or bag is modular and may be made up of an assembly of various garment or bag sub-items. In particular, the digital reference template (1), and potentially, the additional digital reference template (2), may be designed so that at least some of the modular garment or bag sub-items are reversible.

Subsequently, all of the steps relating to the digital production template (3) may be applied to the additional digital production template if the latter exists.

In practice, the execution of a computer program by a microprocessor enables the digital production template (3) to be generated. The latter may be generated randomly, by incrementally adjusting one or more parameters, or by any other means appropriate for a person skilled in the art. The digital production template (3) is preferably generated completely automatically. “Automatically” is understood to mean that the computer program generates the digital production template (3) autonomously, i.e. without user intervention. The computer program preferably comprises a supervised or unsupervised learning algorithm, enabling the digital production template (3) to be generated. The unsupervised learning algorithm may in particular be a generative adversarial network or GAN for short.

The production method which is the object of the invention also comprises the step of:
c) Recording the digital production template (3) in a database.

Thus, once recorded, this digital production template may be used at a later date. In practice, the execution of a computer program by a microprocessor enables the digital production template (3) to be recorded in the database. The database may be arranged on one or more computer mass storage media of the type described above. The database may be relational or object-oriented or a combination of the two.

The production method which is the object of the invention also comprises the step of:
d) Repeating steps b) and c) a determined number of times.

In practice, the execution of a computer program by a microprocessor enables these steps to be repeated. The determined number of times is advantageously greater than or equal to 1000, preferably greater than or equal to 100,000. This provides a library of usable digital templates. The greater the determined number of times, the greater the number of digital production templates available in the database. If, during random generation, the generated digital production template had already been recorded in the database during previous generation, said generated digital production template is not re-recorded in the database and step c) is deemed to have been carried out.

The production method which is the object of the invention also comprises the step of:
e) Establishing at least one selection criterion.

The selection criterion may be mathematical, semantic or any other type appropriate for a person skilled in the art.

The at least one selection criterion may be established in different ways. According to a first exemplary embodiment, step e) may comprise the step of:
e1) Retrieving at least one criterion entered via a user interface.

The user interface is of the same type as the user interface described above. The at least one criterion may be entered by entering one or more key words in a text box, by selecting one or more pre-registered criteria using checkboxes, radio buttons, drop-down menus, or another graphical interface component appropriate for a person skilled in the art. These criteria may comprise body dimensions. They may also comprise terms relating to the shape of the garment or bag, such as long, short, fitted, baggy, etc. They may also comprise terms relating to the use: sport, chic, relaxation, work, etc.

According to a second exemplary embodiment, step e) may comprise the step of:
e2) Acquiring body measurements.

The body measurements may be acquired by means of a three-dimensional (3D) body scanner such as those available on the market or by any other means appropriate for a person skilled in the art.

According to a third exemplary embodiment, step e) may comprise the step of:
e3) Generating at least one selection criterion.

In practice, the execution of a computer program by a microprocessor enables at least one selection criterion to be generated. In particular, the computer program may have a supervised or unsupervised learning algorithm designed to generate at least one selection criterion.

In some exemplary embodiments, step e) may comprise generating at least one selection criterion according to step e3) and/or acquiring body measurements according to step e2), and/or retrieving at least one criterion entered via a user interface according to step e1).

The production method which is the object of the invention also comprises the step of:
f) Selecting, from the database, at least two digital production templates corresponding to the at least one selection criterion.

In practice, the execution of a computer program by a microprocessor enables the digital production templates to be selected. According to one exemplary embodiment, one or more standard criteria may be associated with one or more digital templates in the database.

When at least one standard criterion is associated with a digital production template, the program determines if the selection criterion is identical or similar to one of the associated standard criteria. For example, if the selection criterion is “large” and the associated standard criterion is “long”, the program determines that the two criteria are similar. If the selection criterion is identical or similar to one of the associated standard criteria, the digital production template is selected.

If the selection criterion is not identical or similar to any of the associated standard criteria, the program determines if said selection criterion is contrary to one of the associated standard criteria. For example, if the selection criterion is “large” and the associated standard criterion is “short”, the program determines that the two criteria are contrary. If the selection criterion is contrary to one of the associated standard criteria, the digital production template will not be selected.

If the selection criterion is neither identical or similar, nor contrary to the associated standard criteria, the program can select the digital production template. It may be selected systematically or randomly.

If no standard criterion is associated with a digital production template, the program can select the digital production template.

In alternative embodiments, the method may comprise, in addition to step f), the step of:
f) Selecting, from the database, at least one additional digital production template corresponding to the at least one selection criterion.

The production method which is the object of the invention also comprises the step of:
g) Determining the final digital production template from among the selected digital production templates and possibly the selected additional digital production templates.

According to one exemplary embodiment, the selected digital production templates are proposed to the user who selects the final digital production template using a user interface. The user interface is of the same type as the one described above.

To do this, step g) may comprise the steps of:
g1) Displaying, for each selected digital production template, a three-dimensional rendering of the garment or bag that can be produced in accordance with said template,
g2) Retrieving a selection of the final digital template entered via a user interface.

In practice, the execution of a computer program by a microprocessor enables the three-dimensional rendering of the garment or bag to be displayed. The computer program is of the conventional three-dimensional rendering engine software, well known to a person skilled in the art. The selection of the final digital template may be entered by clicking the mouse on the rendering, or on a button of the graphical interface, or by any other selection means appropriate for a person skilled in the art.

In one alternative embodiment, step g) may comprise the steps of:
g1) Displaying, for each selected digital production template:
g11) A three-dimensional rendering of the garment or bag that can be produced in accordance with said template,
g12) A three-dimensional rendering of the body measurements inside the three-dimensional rendering of the garment or bag,
g2) Retrieving a selection of the final digital template entered via a user interface.

Similarly to the garment or bag, the execution of a computer program by a microprocessor enables the three-dimensional rendering of the body measurements to be displayed. Superimposing the renderings provides a visual check that the proposed digital production template is suitable for the body shape of the person.

The method may advantageously comprise the step of:
j) Recording a piece of correlation data between the at least one selection criterion established and the final digital production template.

Thus, at a later date, if an identical or similar selection criterion is established, it is possible to find this final digital production template which clearly matches the criteria and is therefore a good option for the user. In practice, the execution of a computer program by a microprocessor enables the piece of correlation data to be recorded in a database arranged on a computer mass storage medium of the type described above. The piece of correlation data may comprise a plurality of data, in particular a piece of “criteria” data comprising the selection criterion or criteria established and a piece of “template” data corresponding to a link to the final digital production template.

In order for the piece of correlation data recorded to be used, step f) may then comprise the following steps:
f1) Comparing the at least one selection criterion with each piece of correlation data previously recorded,
f2) Selecting, from the database, at least two digital production templates for which the at least one selection criterion corresponds to the piece of correlation data previously recorded.

In particular, the at least one selection criterion corresponds to the previously recorded piece of correlation data if the selection criterion is similar or identical to the piece of “criteria” data of the piece of correlation data. Step f) may comprise steps f1) and f2), alternatively or in addition to the steps previously described for step f).

Thus, as the production method which is the object of the invention is used, more and more criteria are associated with the digital production templates, which greatly improves the efficiency of the search for digital production templates by criteria.

The production method which is the object of the invention finally comprises the step of:
h) Producing the garment or bag in accordance with the final digital production template.

To do this, the final digital production template may be sent to a digital production unit. The latter may then undertake some or all of the steps required to produce the garment or bag, in particular the material cuts, then assembly, for example by means of sewing, etc. The production unit may comprise a three-dimensional printer and/or a CNC weaving machine and/or a CNC non-woven machine and/or a CNC felting machine and/or a CNC textile cutting machine and/or a CNC sewing machine and/or any other means for producing a garment or bag appropriate for a person skilled in the art. Alternatively or in addition to production via the digital production unit, the final digital production template may be printed or viewed on a screen. A production line is then set up according to the final digital production template. The production line may comprise a weaving machine and/or a non-woven machine and/or a felting machine and/or a textile cutting machine and/or a sewing machine, or any other means for producing a garment or bag appropriate for a person skilled in the art. The garment or bag is then manufactured on the production line set up in this way.

The production method which is the object of the invention may also comprise between step g) and step h), a step of editing the final digital template:
i) Modifying the final digital production template.

In practice, the execution of a computer program by a microprocessor enables the final digital production template to be modified via a user interface of the type described above. Also, and as for steps a0) and a′0), the user interface may be in the form of a virtual or augmented reality interface, and for example comprise a virtual or augmented reality headset. The modifications in step i) may be initiated by one or more movements of the hand of the user, of a remote control, of a stylus or of any other element or means for controlling actions through the virtual or augmented reality interface. For example, the user may use a single movement to create a cutting line on the final digital template.

In one alternative embodiment, step i) may comprise the sub-steps of:
i1) Acquiring new measurements of the moving body,
i2) Extrapolating a new volume from the acquired measurements,
i3) Superimposing the final digital production template and the new volume,
i4) Modifying the final digital production template so that all the final digital production template points surround the volume.

Another aspect of the invention relates to a garment or bag characterized in that it is produced according to the method which is the object of the invention. This production method is particularly well-suited to producing modular garments or bags. These are made up of different parts that can be assembled, or not, as desired, to adapt the garment to a particular style or occasion.

Another aspect of the invention relates to a computer program characterized in that it is designed to be run by a microprocessor so as to carry out the steps of the method for producing a garment or bag which is the object of the invention.

Another aspect of the invention relates to a system for carrying out the method for producing a garment or bag which is the object of the invention. This system is characterized in that is comprises:
A microprocessor able to run a computer program so as to carry out the steps of said production method,
A computer mass storage device on which said computer program is stored, said mass storage device being designed to record the digital reference template (1), the digital production templates (3), and the final digital production template,
A user interface designed to display the selected digital production templates and enable the selection of one of said selected digital production templates so as to determine the final digital production template from among the selected digital production templates,
A digital production unit designed to produce the garment or bag in accordance with the final digital production template.

According to yet another advantageous feature of the invention enabling a realistic rendering of the digital templates, the user interface comprises a virtual reality headset.

1. A method for producing a garment or bag comprising:
a) recording a digital reference template for producing a garment or bag having a set of fixed digital points,
b) generating a digital production template for the garment or bag comprising the set of fixed digital points of the digital reference template and at least one digital line connecting at least two fixed digital points,
c) recording the digital production template in a database,
d) repeating steps b) and c) a determined number of times,
e) establishing at least one selection criterion,
f) selecting, from the database, at least two digital production templates corresponding to the at least one selection criterion,
g) determining the final digital production template from among the selected digital production templates,
h) producing the garment or bag in accordance with the final digital production template.

2. The method according to claim 1, wherein in step d), the determined number of times is greater than or equal to 1000.

3. The method according claim 1, wherein step e) comprises:
e1) retrieving at least one criterion entered via a user interface.

4. The method according to claim 1, wherein step e) comprises:
e2) acquiring body measurements.

5. The method according to claim 1, wherein step g) comprises:
g1) displaying, for each selected digital production template, a three-dimensional rendering of the garment or bag that can be produced in accordance with said template,
g2) retrieving a selection of the final digital template entered via a user interface.

6. The method according to claim 1, wherein step g) comprises:
g1) displaying, for each selected digital production template:
g11) a three-dimensional rendering of the garment or bag that can be produced in accordance with said template,
g12) a three-dimensional rendering of the body measurements inside the three-dimensional rendering of the garment or bag,
g2) retrieving a selection of the final digital template entered via a user interface.

7. The method according to claim 1, further comprising:
j) recording a piece of correlation data between the at least one selection criterion established and the final digital production template.

8. The method according to claim 7, wherein step f) comprises:
f1) comparing the at least one selection criterion with each piece of correlation data previously recorded,
f2) selecting, from the database, at least two digital production templates for which the at least one selection criterion corresponds to the piece of correlation data previously recorded.

9. A garment produced according to the method according to claim 1.

10. (canceled)

11. A system for carrying out the method for producing a garment or bag according to claim 1, the system comprising:
a microprocessor able to run a computer program so as to carry out the steps of said method,
a computer mass storage device on which said computer program is stored, said mass storage device being designed to record the digital reference template, the digital production templates, and the final digital production template,
a user interface designed to display the selected digital production templates and enable the selection of one of said selected digital production templates so as to determine the final digital production template from among the selected digital production templates,
a digital production unit designed to produce the garment or bag in accordance with the final digital production template.

12. The system according to claim 11, wherein the user interface comprises a virtual reality headset.

13. A bag produced according to the method of claim 1.
